(19) United States
(12) Patent Application Publication
(10) Pub. No.: US 2021/0131178 A1
(43) Pub. Date: May 6, 2021

(54) DOOR, IN PARTICULAR SPIRAL DOOR

(71) Applicant: Seuster KG, Lüdenscheid (DE)

(72) Inventor: Jörg FISCHER, Dortmund (DE)

(21) Appl. No.: 16/638,738

(22) PCT Filed: Jul. 3, 2018
(86) PCT No.: PCT/EP2018/067968

§ 371 Date: Feb. 12, 2020

(30) Foreign Application Priority Data
Aug. 18, 2017 (DE) 10 2017 118 959.9

(51) Int. Cl. E06B 9/58

(52) U.S. Cl. CPC E06B 9/58; E06B 9/72

(57) ABSTRACT

The present invention relates to a door (10), in particular a spiral door or roller door, having a flexible curtain or having a plurality of profiles articulated with one another. The door comprises: a door leaf (20) movable starting from a closed position in the course of an opening movement into a multilayered wound position, a guide assembly (30) having a spiral-shaped guide path section (32) for guiding the opening movement in the region of the lateral edge (22) of the door leaf (20), and a flexible traction element (40) attached to a section (24) of the door leaf that leads in the course of the opening movement for pulling the door leaf into the multilayered wound position.

### CROSS REFERENCE TO RELATED APPLICATION

The present application is a 35 U.S.C. § 371 national phase entry application of, and claims priority to, International Patent Application No. PCT/EP2018/067968, filed Jul. 3, 2018, which claims priority to German Patent Application No. DE 102017118959.9, filed Aug. 18, 2017, the disclosures of which are hereby incorporated by reference in their entirety for all purposes.

### BACKGROUND

The present invention relates to a door, in particular a spiral door, having a door leaf movable starting from a closed position in the course of an opening movement into a multilayered wound position or open position and a guide assembly having a spiral-shaped guide path section for guiding the opening movement in the region of the lateral edge of the door leaf.

Doors of this type can be used, for example, for closing garages and hall entries, for closing passages between industrial halls, or also for separating various regions within an industrial hall.

In this case, the door leaf is typically arranged approximately in a vertical plane in the closed position, wherein the lower edge of the door leaf presses against the bottom of the opening to be closed and the door leaf closes the opening. Starting from the closed position, the door leaf is movable upward against the direction of gravity into an open position in the course of an opening movement. In the course of the opening movement, the door leaf is wound into a multilayer winding. The open position, in which the door leaf is arranged in the form of the multilayer winding, is referred to hereafter as the “multilayered wound position”. In this case, the multilayered winding can extend around a winding shaft like a spiral, which shaft is typically arranged behind the lintel forming the upper edge of the opening to be closed. A space-saving housing of the door leaf in the open position is ensured in this way.

The door leaf can be formed in the form of a so-called armored element having a plurality of profiles articulated with one another with respect to joint axes extending perpendicularly to the movement direction of the door leaf. In cases in which burglary-proof closure of the entry is less important than rapid opening of the door opening, the door leaf can be formed in the form of a flexible sheet-shaped curtain and can consist of PVC, for example.

In the case of a roller door described in the document EP 0 531 327 B1, the door leaf is accommodated in the open position with its lateral edges and guide rails having a spiral-shaped guide path section and is supported thereby. To produce the articulated connection between the individual profiles of the roller door leaf, the profiles are equipped on the edges thereof facing toward respective adjacent profiles with engagement devices in the form of so-called insert profiles.

In conventional spiral doors or roller doors, the thrust for moving the door leaf into the open position is typically introduced into the door leaf at the lowermost profile of the armored element. For example, the thrust is transmitted from a drive with the aid of a chain or a toothed belt to the lowermost profile of the armored element, and the door leaf is pushed upward into the open position against gravity. For this purpose, a lateral part is provided on at least one side of the door leaf, in which a circulating chain or a circulating toothed belt is arranged. The force transmission takes place linearly in the vertical direction in such doors. This requires a corresponding space requirement laterally to the door leaf.

In other spiral doors or roller doors, the thrust is introduced using a telescopic boom into the profile of the armored element that leads during the opening movement. The end of the spiral-shaped boom facing away from the winding axis, which is coupled to the edge of the armored element that leads during the opening movement, follows the spiral-shaped path of the profile in this case. Such a door leaf guide is very complex and also has an increased space requirement, however, since the telescopic unit and the drive are to have large dimensions because of the high torque to be applied.

In consideration of the described problems, it is the object of the present invention to provide a door, in particular a roller door or spiral door, the drive and guide assembly of which have a reduced space requirement, and the door leaf of which is movable precisely and reliably between the open and closed positions.

This object is achieved by a door according to claim 1. Advantageous refinements are described in the dependent claims. The door according to the invention has a flexible traction element, which is attached to a section that leads during the opening movement, in particular the leading edge of the door leaf, for pulling the door leaf into the multilayered wound position.

The flexible traction element is fastened, for example, on a leading edge of the door leaf and pulls the door leaf from the closed position against gravity into the multilayered wound position, in which the door leaf extends multiple times around a winding shaft and is arranged in the form of the multilayered winding. If the door leaf is designed as an armored element having a plurality of profiles articulated with one another, the flexible traction element can be attached to the profile that leads during opening, for example, to its lateral edge. If the door leaf is designed as a sheet-shaped curtain, the flexible traction element can be attached to the edge of the curtain that leads during opening or to a side of the curtain reinforcement arranged there.

The flexible traction element is preferably a cable or strap element such as a strap, a rope, a wire cable, a band, a belt, a chain, or a cable, for example. The flexible traction element is preferably a strap such as a flat strap, for example, which can be configured to run on running surfaces of deflection rollers and/or to be wound up on a strap disk.

The invention originates from the finding that due to the force introduction into a section of the door leaf that leads during the opening movement, a vertical force transfer element laterally to the door leaf, such as a circulating chain, is not necessary for force introduction into the lowermost profile. In this way, the lateral part of the door can be embodied in a very space-saving manner. Furthermore, because the force transmission to the door leaf is displaced to its “upper” edge, a crash mechanism can be implemented in a simpler manner in the lower region of the door leaf because of the space savings.

In spiral doors or roller doors having force introduction at the section of the door leaf that leads during the opening movement, the thrust point shifts radially from the outside to the inside in the course of the opening movement because of the spiral-shaped course of the guide path section as the door leaf is wound up, because of which a complex and potentially fragile mechanism and a drive which has large dimensions can be required in spiral doors having telescopic booms. The present invention is also based on the finding that a flexible traction element, such as a strap for pulling the door leaf into the wound position, can extend because of its flexibility without problems along a path narrowing in a spiral shape, so that a complex mechanism and large-dimensioned drives are not required upon use of the flexible traction element. Rather, a flexible traction element can pull the door leaf, independently of the course of the guide path of the door leaf, along this guide path into the wound position and in this case can follow the spiral-shaped course of the guide path between the region of the force introduction into the door leaf and a storage unit, such as a strap disk, on which the traction element, which is embodied as a strap, for example, is wound in the course of the opening movement.

In a door according to the invention, in particular a spiral door, the door leaf is preferably arranged in the multilayered wound position in the form of a winding having layers spaced apart from one another. In other words, the individual winding layers of the multilayered winding preferably do not press against one another, in contrast to the case of a simple roller shutter. In this way, the risk of damage to the door leaf during the winding and unwinding can be reduced. For example, two adjacent winding layers of the winding have a spacing of 1 cm or more, in particular 5 cm or more, from one another in the open position. Adjacent turns of the spiral-shaped guide path section of the guide assembly can be spaced apart from one another accordingly.

A reliable opening mechanism for opening the door leaf can be provided in that the flexible traction element is attached, on the one hand, to the leading section of the door leaf and, on the other hand, to a rotatable winding shaft arrangement, around which the door leaf extends like a spiral in the wound position.

The rotatable winding shaft arrangement preferably comprises a winding shaft, which extends perpendicularly in relation to the movement direction of the door leaf, and which can be arranged above the opening to be closed using the door leaf and/or behind the lintel of the door opening to be closed. The flexible traction element can be fastened on the winding shaft arrangement in such a way that it can be wound thereon.

In one preferred embodiment of the invention, the front end of the flexible traction element is fastened on the leading section of the door leaf and the rear end of the flexible traction element, which is opposite to the front end, is fastened on the winding shaft arrangement. When the winding shaft arrangement rotates, the flexible traction element is wound onto the winding shaft arrangement, and at the same time pulls on the leading section of the door leaf, so that the door leaf can be moved along the spiral-shaped guide path section into the wound position.

Reliable winding and unwinding of the flexible traction element on the winding shaft arrangement can be ensured by a strap disk, on which the flexible traction element can be wound in the course of the opening movement. The strap disk is preferably connected in a rotationally-fixed manner to a winding shaft of the winding shaft arrangement, so that it rotates together with the winding shaft. The strap disk can comprise a guide for the flexible traction element. For example, the width of the strap disk is adapted to the width of the flexible traction element. In one embodiment, the strap disk comprises two collars protruding in a ring shape from the winding shaft, between which the flexible traction element can be wound.

The strap disk is preferably fastened on a lateral edge section of the winding shaft. For example, the strap disk is arranged in an end section of the winding shaft which protrudes laterally out of the multilayered winding when it is wound around the winding shaft in the open position. In this way, the flexible traction element can be wound onto the strap disk in the course of the opening movement, without obstructing the forming winding of the door leaf or being obstructed thereby.

It is to be noted in this context that the door preferably comprises a guide assembly having a spiral-shaped guide path section in each case on both sides (i.e., on a right side and a left side of the door opening), wherein at least one flexible traction element for pulling the door leaf into the multilayered wound position is arranged on each side of the door leaf. For example, a first flexible traction element is attached on a first side of the section of the door leaf that leads during the opening movement, and a second flexible traction element is attached on a second side of the section of the door leaf that leads during the opening movement. In this way, a symmetrical force introduction on both sides of the door leaf is possible, and the door leaf can be pulled uniformly and without the risk of jamming into the multilayered wound position. In this case, the winding shaft arrangement can comprise a winding shaft having two strap disks in two opposing edge sections of the winding shaft.

At least one door drive can be provided for moving the door leaf. The door drive can be configured to drive the winding shaft arrangement such that it rotates around its own axis. In some embodiments, the door drive is a tube drive, which is arranged at least partially in the interior of the winding shaft. For example, the door drive is a tube motor arranged in the winding shaft. A tube drive has the advantage that less space for a drive unit is required laterally to the winding shaft, so that a compact and space-saving structural form can be provided.

Alternatively, the door drive can be a drive flanged axially onto the winding shaft, such as a direct mount drive. A door drive arranged axially on the winding shaft can typically provide an increased torque in relation to a tube drive, so that such a drive can be used, for example, with larger doors.

The flexible traction element is preferably guided on an approximately spiral-shaped traction path in the course of the opening movement. In a first possible embodiment, the flexible traction element is guided, for example, by the spiral-shaped guide path section of the guide assembly, by which the door leaf is also guided.

In one particularly preferred embodiment, the flexible traction element is guided on a spiral-shaped traction path, the course of which essentially emulates the course of the spiral-shaped guide path section of the guide assembly. For example, the spiral-shaped traction path for the flexible traction element extends adjacent to the spiral-shaped guide path section for guiding the door leaf, for example, laterally offset thereto. In this manner, the flexible traction element can pull the door leaf without collision along the spiral-shaped guide path section into the multilayered wound position. The turns of the spiral-shaped traction path can also be arranged between those of the guide path.

The flexible traction element is preferably guided and supported in this case on a plurality of preferably rotatably mounted deflection rollers, which are arranged in such a way that they provide the approximately spiral-shaped traction path for the flexible traction element. When the flexible traction element is guided externally on the rolling surfaces of the deflection rollers, it is arranged approximately in a spiral shape. For example, the rotational axes of the deflection rollers are arranged approximately on a spiral path, the course of which approximately corresponds to the course of the spiral-shaped guide path section and/or is arranged essentially in parallel or offset thereto or extends between the turns of the guide path.

The flexible traction element, for example, the strap, runs linearly between each two adjacent deflection rollers. The more deflection rollers are therefore provided to form the spiral-shaped traction path, the “rounder” the resulting spiral-shaped course of the flexible traction element in the open position of the door leaf will be.

In some embodiments, 10 or more, in particular 20 or more deflection rollers are provided for guiding the flexible traction element on the approximately spiral-shaped traction path. For example, two, three, or more (or “n”) deflection rollers are each arranged along a straight line extending radially outward starting from the winding shaft as the center, wherein each of these two, three, or more (or “n”) deflection rollers is associated with one winding turn of the spiral-shaped traction path. In this case, the door leaf can be pulled by the flexible traction element guided along the spiral-shaped traction path into a winding layer having two, three, or more (or “n”) winding layers.

Two deflection rollers which are adjacent along the course of the traction path can be arranged at an angle of 60° or less, in particular 45° or less, with respect to the winding shaft. For example, six or more, in particular eight or more deflection rollers are associated with each winding turn of the traction path and are arranged along an arc around the winding shaft as the center. The arcs can be circular arcs having a constant radius or arcs having a radius gradually decreasing from deflection roller to deflection roller. In this context, it is to be noted that a spiral-shaped path is generally understood as a guide path which extends in multiple turns around the winding shaft as the center and the spacing of which from the winding shaft decreases in this case from turn to turn. A spiral is thus not necessarily a circular spiral or a round spiral. The use of oval spirals according to EP 0 531 327 B1 is also considered, in which sections curved like an oval are connected to one another by sections extending approximately linearly.

In the case of three winding turns of the spiral-shaped traction path each having eight deflection rollers arranged at a neighboring angle of 45° in each case, for example, a total number of 24 deflection rollers results, which provide the spiral-shaped traction path. In other embodiments, more or fewer than 24 deflection rollers can be provided.

In the closed position of the door leaf, at least a part of the flexible traction element is unwound from the strap disk and extends along the spiral-shaped traction path on outer rolling surfaces of the plurality of deflection rollers. The door leaf is arranged essentially vertically in this case and does not engage or only engages insignificantly in the spiral-shaped guide path section of the guide assembly.

In the course of the opening movement of the door leaf, the door leaf is pulled by the flexible traction element along the spiral-shaped guide path section, the course of which can essentially correspond to the course of the spiral-shaped traction path of the flexible traction element. At the same time, the flexible traction element can be wound onto a strap disk.

In the open position of the door leaf, a flexible traction element is not guided at least on the outer deflection rollers remote from the winding shaft, since this traction element is at least partially wound onto the strap disk. Instead, guide elements provided on the lateral edge of the door leaf engage here in the spiral-shaped guide path section of the guide assembly.

In one particularly preferred embodiment of the invention, the plurality of deflection rollers in the region of the lateral edge of the door leaf is held on the side facing away from the door leaf of a guide slot of the guide assembly. The guide slot can be formed to be spiral-shaped at least in sections and can form the spiral-shaped guide path section. The flexible traction element can be fastened on a guide element of the door leaf engaging in the guide slot. In this way, the door leaf can be drawn precisely and accurately by the flexible guide element along the spiral-shaped guide slot.

Exact and trouble-free guiding of the door leaf along the guide assembly can be ensured by a plurality of guide elements which protrude on the lateral edge of the door leaf and engage in the guide assembly. The guide elements can be rotatably attached on the lateral edge of the door leaf in this case and can be formed, for example, as roller elements or pin elements.

In one particularly preferred embodiment of the invention, the guide elements of the door leaf are guided in the course of the opening movement of the door leaf in the spiral-shaped guide path section. The spiral-shaped guide path section can be formed for this purpose as a spiral-shaped guide slot, the slot width of which can be adapted to a width of the guide elements. To avoid sliding of the guide elements out of the guide slot, a section of each of the guide elements engaging through the guide slot can be widened.

The spiral-shaped guide path section can be formed by a spiral-shaped guide slot formed in a guide plate. The guide plate can be a laser-cut plate having guide slot, in which guide elements of the door leaf formed as roller elements run. In a first possible embodiment without deflection rollers, the flexible traction element is also guided in the guide slot of the guide assembly. However, this can result in increased wear of the flexible traction element due to friction. The plurality of deflection rollers is therefore provided in one preferred embodiment of the invention, which are arranged in such a way that they provide a traction path for the flexible traction element emulating the course of the guide slot.

The flexible traction element is preferably attached to the guide element of the door leaf that leads in the course of the opening movement. In particular, the flexible traction element is attached to a section of the leading guide element of the door leaf that engages through a guide slot of the guide assembly. The flexible traction element and the deflection rollers are preferably arranged protected behind a guide plate of the guide assembly, for example, on a side facing away from the door leaf of the guide slot formed in the guide plate. In this way, damage to the flexible guide element can be prevented and uniform guiding of the door leaf along the guide slot can be enabled.

As already mentioned above, the guide assembly can comprise a guide plate equipped with the guide slot, which is preferably produced by laser processing. Additionally or alternatively, the guide assembly can comprise a guide rail closed on the side facing away from the guide slot by means of a rail wall, in particular a steel, aluminum, and/or plastic rail which is profiled or embodied as an extruded profile, and which optionally extends in a spiral shape. To provide a smooth contact surface for guide elements of the door leaf and/or the flexible traction element while simultaneously ensuring exact guiding of the door leaf movement with the aid of a precise guide slot, the guide rail can be embodied as a G-rail and can comprise a running surface for a guide element of the door leaf which is arranged between the guide slot and the rear wall and optionally extends in a spiral shape. Additionally or alternatively, a deflection roller for the traction element and/or a guide roller for the door leaf rotatable around a fixed axis can be provided, which can optionally be accommodated in a guide rail embodied as a C-rail.

It has proven to be particularly advantageous if the running surface extends starting from the guide slot in the direction of the rear wall and ends with spacing from the rail wall. In this case, sufficient space still remains between running surface and rail wall for housing a deflection roller for the traction element possibly embodied as a strap.

The force transmission via the flexible traction element extending in a spiral shape can be coupled to various door leaf variants.

In some embodiments, the door leaf is an at least partially flexible curtain, preferably a sheet-shaped plastic curtain. The curtain is not necessarily completely flexible, but rather can comprise multiple flexible sections, between which reinforcements can be arranged, which can be used, for example, for wind protection. The curtain can consist at least partially of sheet elements made of polycarbonate (PC). A light door leaf can be opened rapidly and can be produced and transported cost-effectively. For example, the door can be formed as a high-speed door which can close, for example, a passage between two sections of a hall. A door leaf formed as a flexible curtain can repeatedly be curved from an essentially planar position into a multilayered wound position and back into the planar position again. In this case, strap hinges can be arranged on the lateral edges of the curtain, which are coupled to stabilization profiles of the curtain.

In one particularly preferred embodiment, the door leaf is formed as an armored element made of aluminum and elements made of polycarbonate.

The stability and break-in resistance of the door can be improved in that the door leaf is an armored element having a plurality of rigid profiles articulated with one another, for example, via hinges or strap hinges. For example, the door is formed as a roller door or spiral door having laminar armor. Because of the articulated connectors of the profiles, the door can be moved from a planar position into the multilayered wound position and back into the planar position again.

The embodiment of doors is also considered in the scope of the invention, in which the door leaf consists of a combination of rigid profiles and a yielding curtain, wherein the yielding curtain can be provided in particular in the region of the edge of the door leaf that leads during the closing movement.

In all embodiments of the invention, an elastically deformable stabilizing element can be provided on the edge of the door leaf that leads during the closing movement, in which the restoring force acting in a direction opposite to the closing direction upon a deformation of the stabilizing element is less than the restoring force counteracting a deformation of the stabilizing element in a direction extending transversely thereto, in particular approximately perpendicularly to the closing element in the closed position, to thus reduce the risk of injury in the event of an impact of the stabilizing element on an object or a person in the course of the closing movement.

Corresponding stabilizing elements are described in EP 1604091 B2. The content of the disclosure of this document with respect to the embodiment of elastically deformable stabilizing elements is hereby incorporated by express reference into this description. The stabilizing element can accordingly comprise a leaf spring embedded in elastomer material having main surface aligned perpendicularly to the closing direction.

According to a further aspect, the present invention relates to a method for opening a door, in particular a roller door or spiral door. According to the method according to the invention, a door leaf is pulled by means of a flexible traction element from a closed position into a multilayered wound position. The traction element can be formed as a strap. The flexible traction element is attached to a section of the door leaf that leads during the opening of the door leaf. In the region of its lateral edge, the door leaf can be guided by a guide assembly having a spiral-shaped guide path section.

In one preferred embodiment of the invention, the flexible traction element is guided on a traction path extending approximately in a spiral shape during the pulling of the door leaf into the multilayered wound position. The spiral-shaped traction path of the flexible traction element can emulate the course of the spiral-shaped guide path section of the door leaf. In this manner, the flexible traction element can pull the door leaf without collision along the spiral-shaped guide path section into the multilayered wound position.

The flexible traction element is preferably guided in this case on a plurality of deflection rollers, which are arranged in such a way that the flexible traction element is arranged approximately in a spiral shape when it is guided on the outside on the rolling surfaces of the deflection rollers. For example, the axes of rotation of the deflection rollers are arranged on a spiral path, the course of which can essentially correspond to the spiral-shaped guide path section and/or which is arranged essentially in parallel or offset thereto.

In the course of the opening movement, the flexible traction element is preferably wound onto a rotating winding shaft arrangement. In particular, the winding shaft arrangement comprises a strap disk, onto which the flexible traction element is wound.

### BRIEF DESCRIPTION OF THE DRAWINGS

The invention is explained hereafter with reference to the drawing, to which reference is expressly made with respect to all details essential to the invention and not expressly emphasized in the description. In the figures of the drawing:

FIG. 1 shows a schematic view of a portion of a door according to the invention,

FIG. 2 shows a schematic view of a guide assembly for guiding the door leaf from FIG. 1,

FIG. 3 shows a schematic view of the portion of the door according to the invention from FIG. 1 with the guide assembly from FIG. 2,

FIG. 4 shows a schematic view of a door according to the invention,

FIG. 5 shows a schematic sectional view of a guide assembly according to a further embodiment of the invention,

FIG. 6 shows a schematic sectional view of a guide assembly according to a third embodiment of the invention,

FIG. 7 shows a schematic view of the guide assembly according to FIG. 5, and

FIG. 8 shows a schematic arrangement of the guide assembly according to FIG. 6.

### DETAILED DESCRIPTION

FIG. 4 is a schematic view of a door 10 according to the invention, for example a spiral door or roller door, having a door leaf 20 for closing a door opening. FIG. 4 shows the door leaf 20 in the closed position, in which it closes the door opening and is arranged essentially vertically, wherein the lower door leaf edge rests on the bottom of the door opening to be closed.

The door leaf 20 can be moved against the direction of gravity into an open position, in which the door leaf 20 is arranged in the form of a multilayered winding in a multilayered wound position. The individual winding layers preferably do not touch one another in the wound position and/or in the course of the opening movement, to avoid damage to the door leaf and to enable exact guiding from the closed position into the open position.

The door leaf 20 comprises a door leaf section 24 that leads in the course of the opening movement and a door leaf section that trails in the course of the opening movement. Furthermore, the door leaf comprises two lateral edges 22, at each of which the door leaf 20 is guided by means of a guide assembly 30, which can comprise a guide slot or a guide rail. In the closed position shown in FIG. 4, the door leaf is guided in the region of its lateral edges 22 in approximately vertically extending guide path sections of the guide assembly 30, which are solely indicated by dashed lines. The guide assembly 30 comprises a spiral-shaped guide path section 32, in which the lateral edges 22 of the door leaf are guided during the movement into the multilayered wound position. The spiral-shaped guide path section 32 is also indicated as a dashed line in FIG. 4.

In the multilayered wound position, the door leaf 20 encloses a winding shaft arrangement 50 in the form of a multilayered winding. The winding shaft arrangement 50 can comprise a winding shaft extending essentially horizontally above the door opening and/or behind a lintel of the door opening. The winding shaft arrangement 50 can be driven by means of a door drive which can be designed, for example, as a tube motor.

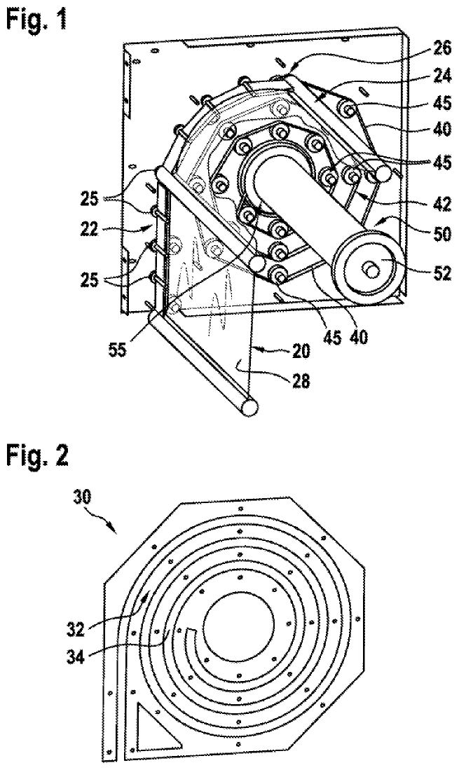

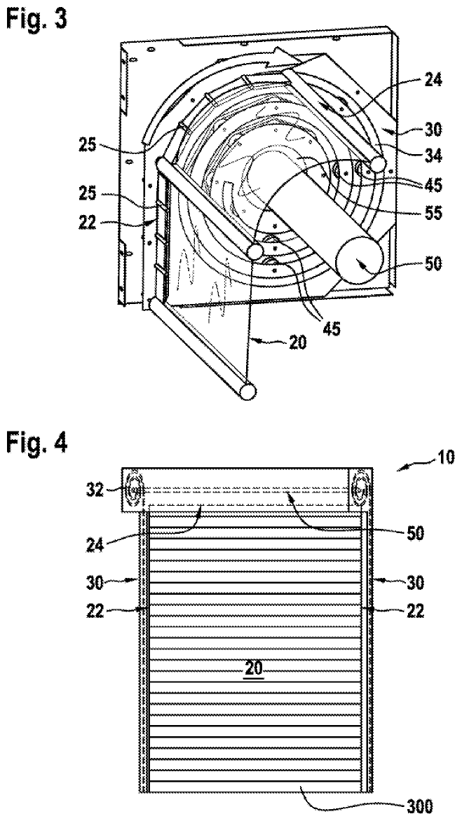

FIG. 1 shows a schematic view of an upper portion of a door 10 according to the invention, as is shown by way of example in FIG. 4. In this case, the guide assembly 30 for guiding the door leaf 20 is omitted in consideration of better clarity in FIG. 1. The guide assembly 30 is shown separately in FIG. 2. FIG. 3 shows the upper portion of the door 10 according to the invention from FIG. 1 having the guide assembly 30 from FIG. 2 attached thereon.

In FIG. 1 and FIG. 3, the door leaf 20 is shown in the course of an opening movement, in which the door leaf 20 is moved upward into the multilayered wound position. For this purpose, a flexible traction element 40, such as a strap for pulling the door leaf 20 into the multilayered wound position, is attached to the leading section 24 of the door leaf 20.

In the embodiment shown in FIG. 1, the door leaf 20 is formed as a partially flexible curtain 28, which can comprise reinforcements extending perpendicularly to the movement direction of the door leaf, which can be used for wind protection. The strap can be attached to a lateral edge section of the door leaf reinforcement that leads in the course of the opening movement. The lateral edges are embodied as strap hinges which are fastened to the reinforcements, as described in EP 16 002 133.3.

The flexible traction element 40 is guided by a plurality of deflection rollers 45 along a spiral-shaped traction path 42. The course of the spiral-shaped traction path 42 essentially corresponds to the course of the spiral-shaped guide path section 32 (see FIG. 2), along which the leading section 24 of the door leaf 20 is guided in the course of the opening movement of the door leaf.

In the embodiment shown in FIG. 1, twenty or more deflection rollers 45 are provided for guiding the flexible traction element 45 along the spiral-shaped traction path 42. In an alternative embodiment, the flexible traction element 45 can also be guided in a sliding manner on a continuous spiral path, for example, on the spiral-shaped guide path section 32 of the guide assembly 30. The guiding of the flexible traction element 40 by means of the deflection rollers 45, which are preferably rotatable with respect to axes of rotation extending coaxially to hinge axes of the strap hinges 22, decreases the wear of the flexible traction element 40 and the traction required for pulling the door leaf into the open position, however.

The deflection rollers 45 can be arranged in such a way that the rotational axes thereof are located essentially on a spiral path having two, three, or more turns. Preferably, six, eight, or more deflection rollers are associated with each of the turns, so that a path emulating a circular spiral can be provided for the flexible traction element by the deflection rollers 45. A high number of deflection rollers arranged with small spacing has the result that the spiral-shaped traction path 42 is particularly similar to the spiral-shaped guide path section 32, which is preferably formed as a circular spiral, whereby the guide of the door leaf can be improved and the required traction can be reduced.

As shown in FIG. 1, the flexible traction element 40 can be attached, on the one hand, to the leading section 24 of the door leaf 20 and, on the other hand, to a strap disk 55, which is held in a rotationally-fixed manner on the winding shaft 52 of the winding shaft arrangement 50. The strap disk 55 is adapted to the flexible traction element 40 in such a way that it can be wound without the risk of crossing over or jamming on the strap disk 55 and unwound therefrom. A second strap disk optionally arranged on the opposing end of the winding shaft 52 is also shown in FIG. 1, on which an optional second flexible traction element is wound during the movement of the door leaf into the open position. A symmetrical force introduction into the door leaf is ensured by a second flexible traction element.

A door drive designed as a tube drive for driving the winding shaft 52 can be arranged in the winding shaft 52. Alternatively, a door drive can also be provided which is arranged in axial extension of the winding shaft 52 and is designed, for example, as a direct mount drive.

FIG. 2 shows a schematic view of the spiral-shaped guide path section 32 of the guide assembly 30. The spiral-shaped guide path section 32 can be formed as a spiral-shaped guide slot 34 introduced into a guide plate. Guide elements 25 of the door leaf can engage into or through the guide slot 34, so that the door leaf can be guided along the spiral-shaped guide slot 34 into the multilayered wound position. As shown in FIG. 3, the spiral-shaped guide path section 32 is arranged on one side of the door leaf 20 in such a way that the winding shaft arrangement 50 extends through its central opening.

It can be seen particularly well in FIG. 1 that the guide elements 25 of the door leaf are rotatable pin or roller elements protruding on the lateral edge 22 of the door leaf 20. FIG. 3 shows that these guide elements 25 can engage through the guide slot 34 of the guide assembly 30, so that the front sections thereof are accommodated in an intermediate space between the guide plate of the guide assembly 30 and a side wall. The deflection rollers 45 for the flexible traction element can also be held rotatably in this intermediate space. The deflection rollers 45 are held, for example, in the region of the lateral edge 22 of the door leaf 20 on the side facing away from the door leaf of the spiral-shaped guide slot 34 of the guide assembly 30.

FIG. 1 furthermore shows that the flexible traction element 40 is attached to the guide element 26 of the door leaf that leads in the course of the opening movement, in a section which engages through the guide slot 34.

As can be seen from FIG. 3, the door leaf 20 is arranged in the multilayered wound position in the form of a winding having layers spaced apart from one another. The spacing of the layers of the door leaf in the open position essentially corresponds to the spacing of adjacent turns of the spiral-shaped guide groove 34. In this case, the strap hinges 22 are arranged on the side of the guide plate facing toward the curtain, while the traction element is arranged on the side of the guide plate facing away from the curtain.

As indicated in FIG. 4 at 300, in all embodiments of the invention, an elastically deformable stabilizing element can be provided in the region of the edge of the door leaf that leads during the closing movement, in which the restoring force counteracting a deformation of the stabilizing element in a direction counteracting the closing direction is less than the restoring force counteracting a deformation of the stabilizing element in a direction extending transversely thereto, in particular approximately perpendicularly to the closing element in the closed position. The risk of damage to objects and/or injury to persons during a door leaf closing movement can thus be avoided, while simultaneously a sufficient stabilizing effect is achievable in a direction extending perpendicularly to the door leaf plane.

The use of corresponding stabilizing elements has proven to be advantageous in particular if at least the lower region of the door leaf in the closed position is embodied in the form of a yielding curtain enabling a deformation. With such door leaves, in which the lower region in the closed position is embodied as a yielding curtain, the coupling provided according to the invention of a flexible traction element on the section of the door leaf that leads during the opening movement can also be used particularly advantageously, because the drive can be coupled to the door leaf without consideration of the stability of the door leaf in the region that leads during the closing movement.

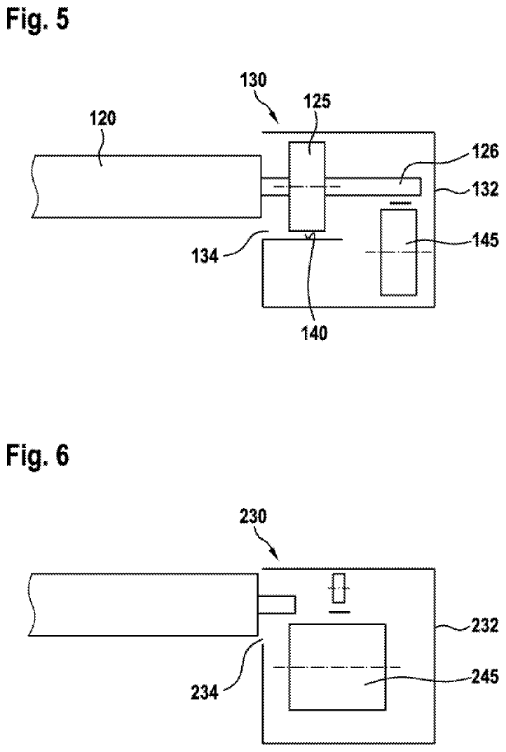

In the embodiment of the invention shown in FIG. 5, the guide assembly comprises a guide rail embodied as a profiled steel plate or as an aluminum extruded profile or plastic extruded profile, which is embodied as a G-rail. A guide roller 125, which is attached to the door leaf 120, and the roller axis of which penetrates a guide slot 134, can be accommodated in the guide rail or the guide profile. The guide rail 130 is embodied as closed in the plane of section shown in FIG. 5, which extends perpendicularly to the movement path, with the exception of the guide slot 134. The guide rail has a rail wall 132 arranged on the side facing away from the guide slot 134.

A running surface 140, which extends starting from the guide slot in the direction of the rail wall 132 and is essentially planar or circumferential in a spiral shape, is provided in the guide rail 130. This running surface 140 extends approximately in parallel to the movement direction of the door leaf 120 and is used as a support for the rollers attached to the door leaf 120. During the opening or closing movement, the rollers 125 roll on the running surface 140 of the guide rail 130.

A deflection roller 145 for a traction element fastened via a holder 126 on the door leaf 120, such as a strap, is illustrated by way of example between the edge of the running surface 140 facing toward the rail wall 132 and the rail wall 132. Instead of the embodiment shown in FIG. 5, the guiding of the traction element can be performed via the running surface 140 while dispensing with a separate deflection roller 145. In both embodiments of the invention, a smooth contact surface for the guide roller and optionally the strap is provided by the running surface 140. This is advantageous for smooth door running.

The embodiment of the invention shown in FIG. 6 essentially differs from the embodiment explained on the basis of FIG. 5 in that, while dispensing with a running surface 140, a guide roller 245 rotatable around a fixed axis of rotation is accommodated in the guide rail 230. This guide roller is used both for guiding the traction element and also for guiding a sliding element of the door leaf which is used simultaneously as the holder for the traction element. The guide rails shown in FIGS. 5 and 6 can be embodied as profiled steel plates, as noted. However, they can also be produced as extruded profiles.

In the embodiments of the invention explained by way of example on the basis of FIGS. 5 and 6, various types of arrangements of the guide elements and deflection rollers can be selected. Guide elements and deflection rollers can be arranged offset in relation to one another in a direction extending perpendicularly to the movement direction of the door leaf. The guide rollers can have a double function and can be used simultaneously for guiding the traction element and for guiding the door leaf.

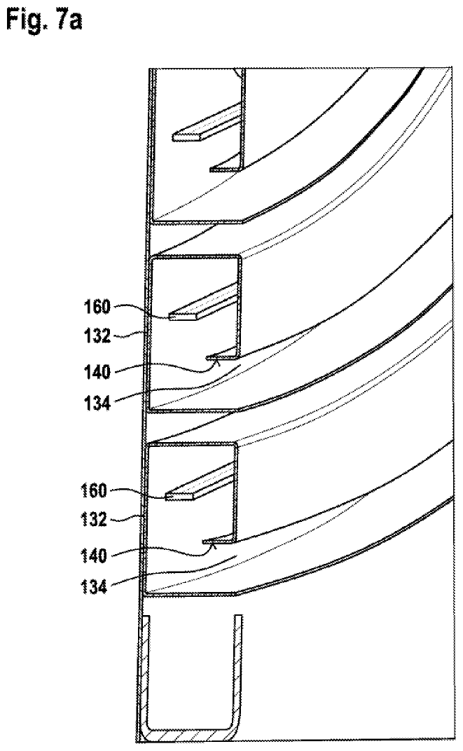

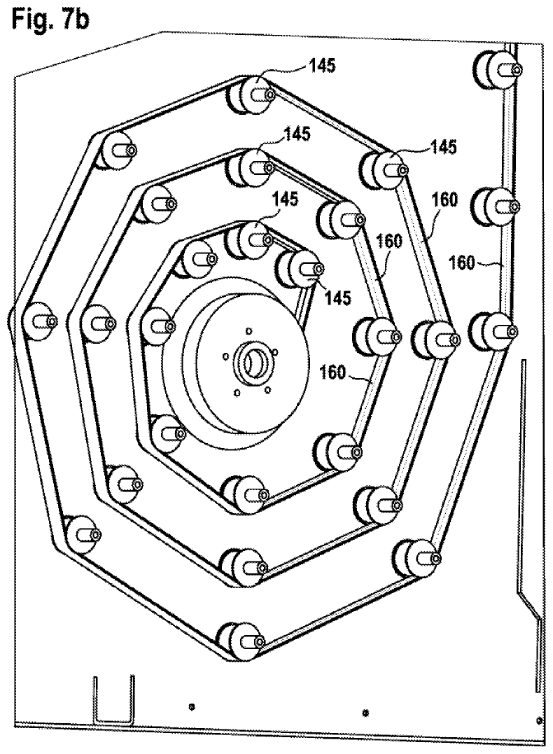

In FIG. 7a, the course of the guide rails 130 in the embodiment illustrated in FIG. 5 is indicated in partial perspective. FIG. 7b schematically shows the arrangement of the deflection rollers 145, for the traction element embodied as a strap 160, within the guide rails 130.

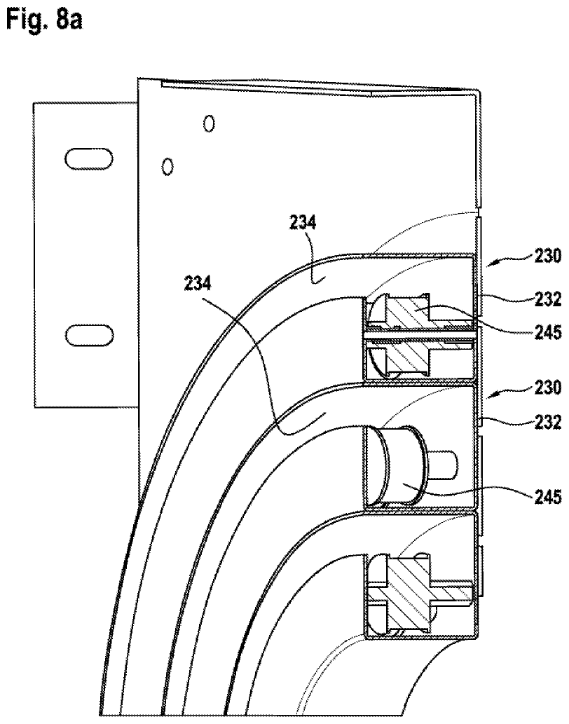

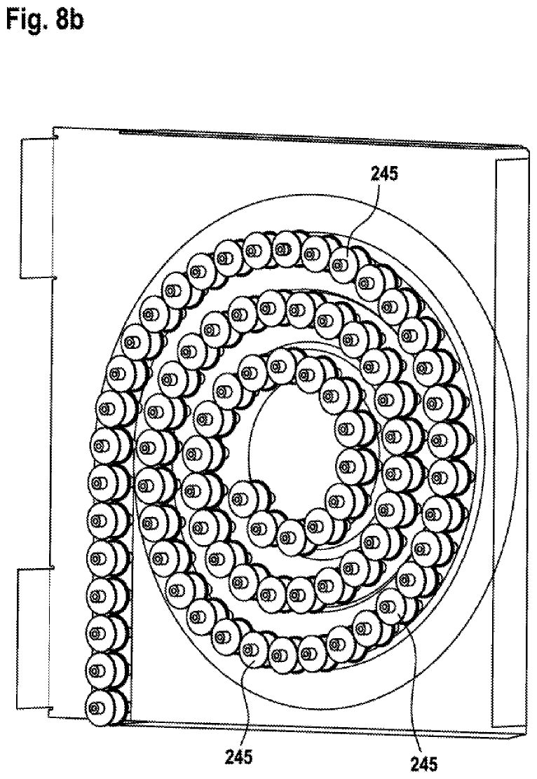

FIG. 8a shows the guide rails shown in FIG. 6 in a schematic perspective view. In this case, the guide rollers 245 assume a double function, by functioning as a deflection roller for the traction element embodied as a strap, on the one hand, and being used for guiding the door leaf movement, on the other hand. The guide rollers comprise a receptacle for the guide strap, which is delimited on both sides by a protruding shoulder in each case. As soon the guide strap is accommodated in the receptacle, the guide strap and the shoulder arrangements arranged on both sides thereof form a planar support surface for the guiding of the door leaf movement. FIG. 8b schematically shows a possible arrangement of the guide rollers 245 within the guide rails 230.

Instead of a door leaf in the form of a sheet-shaped curtain, a door leaf designed in the form of an armored element having a plurality of profiles articulated with one another can be provided.

The door can furthermore comprise a control unit for controlling the door leaf movement and/or for generating control signals used for stopping the door leaf movement, for example, if an obstacle in the movement path of the door leaf is detected by means of a sensor. The sensor can comprise, for example, a photocell, onto which a light beam of a light source can be oriented.

The invention is not restricted to the embodiment explained on the basis of the drawing. Rather, the opening mechanism according to the invention is also usable in other types of doors, the door leaves of which are movable into a multilayered wound position. Furthermore, the door leaf can comprise multiple flexible traction elements such as straps for pulling the door leaf into the open position. In the present disclosure, in particular the opening movement for opening the door leaf was described. Vice versa, the door leaf is similarly closable again, of course, wherein the door leaf can move back into the closed position under the effect of gravity when the tension of the flexible traction element diminishes.

### LIST OF REFERENCE NUMERALS

10 door

20 door leaf

22 lateral edge of the door leaf

24 leading section of the door leaf

25 guide elements

26 leading guide element

28 flexible curtain

30 guide assembly

32 spiral-shaped guide path section

34 guide slot

40 flexible traction element, in particular strap

42 spiral-shaped traction path

45 deflection rollers

50 winding shaft arrangement

52 winding shaft

55 strap disk

120 door leaf

125 guide roller

126 holder

130 guide rail

132 rail wall

134 guide slot

140 running surface

145 deflection roller

230 guide rail

232 rail wall

234 guide slot

245 deflection roller

300 stabilizing element

1. A door having a door leaf movable starting from a closed position in the course of an opening movement into a multilayered wound position and a guide assembly having a spiral-shaped guide path section for guiding the opening movement in the region of the lateral edge of the door leaf, characterized by a flexible traction element, which is attached to a section of the door leaf that leads during the opening movement, for pulling the door leaf into the multilayered wound position.

2. The door according to claim 1, characterized in that the door leaf is arranged in the form of a winding having layers spaced apart from one another in the multilayered wound position.

3. The door according to claim 1, characterized in that the flexible traction element is a strap, a band, a chain, or a rope.

4. The door according to claim 1, characterized in that the flexible traction element is attached, on the one hand, to the leading section of the door leaf and, on the other hand, to a rotatable winding shaft arrangement, around which the door leaf extends like a spiral in the wound position.

5. The door according to claim 4, characterized in that the winding shaft arrangement comprises a strap disk, which is arranged in a rotationally-fixed manner on a winding shaft, and on which the flexible traction element can be wound in the course of the opening movement.

6. The door according to claim 4, characterized by a door drive for driving the winding shaft arrangement, in particular in the form of a tube drive in the winding shaft of the winding shaft arrangement.

7. The door according to claim 1, characterized in that the flexible traction element is guided in the closed position on an approximately spiral-shaped traction path, the course of which preferably essentially emulates the course of the spiral-shaped guide path section of the guide assembly.

8. The door according to claim 1, characterized in that the flexible traction element is guided on a plurality of preferably rotatably mounted deflection rollers which are arranged in such a way that they provide an approximately spiral-shaped traction path for the flexible traction element.

9. The door according to claim 8, characterized in that the deflection rollers are held in the region of the lateral edge of the door leaf on the side facing away from the door leaf of a guide slot of the guide assembly.

10. The door according to claim 1, characterized by a plurality of guide elements, which protrude on the lateral edge of the door leaf, engage in the guide assembly, and are preferably rotatably attached to the door leaf, and which are guided in the course of the opening movement of the door leaf in the spiral-shaped guide path section preferably formed as a guide slot.

11. The door according to claim 10, characterized in that the flexible traction element is attached to the guide element of the door leaf that leads in the course of the opening movement.

12. The door according to claim 1, characterized in that the door leaf is an at least partially flexible curtain, preferably a plastic curtain, in particular a plastic curtain which comprises polycarbonate.

13. The door according to claim 1, characterized in that the guide assembly comprises a guide plate equipped with the guide slot, which is preferably produced by laser processing.

14. The door according to claim 1, characterized in that the guide assembly comprises a guide rail, which is closed on the side facing away from the guide slot by means of a rail wall, and which comprises in particular a steel, aluminum, and/or plastic rail that is profiled or embodied as an extruded profile.

15. The door according to claim 13, characterized in that the guide rail comprises a running surface, which is arranged between the guide slot and the rear wall and optionally extends around in a spiral, for a guide element of the door leaf and/or a deflection roller for the traction element and/or a guide element of the door leaf.

16. The door according to claim 1, characterized in that the door leaf is an armored element having a plurality of profiles articulated with one another.

17. The door according to claim 1, characterized in that an elastically deformable stabilizing element is arranged on the edge that leads during a closing movement, in the case of which a restoring force counteracting a deformation of the stabilizing element in a direction opposite to the closing direction is less than a restoring force counteracting a deformation of the stabilizing element in a direction extending transversely thereto, in particular approximately perpendicularly to the door leaf in the closed position.

18. A method for opening a door, which comprises:
pulling a door leaf from a closed position into a multilayered wound position by means of a flexible traction element, in particular a strap, which is attached to a leading section of the door leaf, while the door leaf is guided in the region of its lateral edge by a guide assembly having a spiral-shaped guide path section.

19. The method according to claim 14, characterized in that the flexible traction element is guided on an approximately spiral-shaped traction path, preferably on a plurality of deflection rollers, and/or is wound on a winding shaft arrangement during the pulling of the door leaf into the multilayered wound position.
